(19) United States
(12) Patent Application Publication
(10) Pub. No.: US 2024/0168589 A1
(43) Pub. Date: May 23, 2024

(54) CONTROLLING A USER INTERFACE OF A VEHICLE

(71) Applicant: Volvo Car Corporation, Göteborg (SE)

(72) Inventor: Reza Javaheri, Göteborg (SE)

(21) Appl. No.: 18/512,209

(22) Filed: Nov. 17, 2023

(30) Foreign Application Priority Data
Nov. 18, 2022 (EP) 22208361.0

(51) Int. Cl. G06F 3/041; G06F 3/01; G06F 3/04886; G06N 20/00

(52) U.S. Cl. CPC G06F 3/04186; G06F 3/011; G06F 3/04886; G06N 20/00

(57) ABSTRACT

Control of at least one user interface of a vehicle is enabled. A method for controlling at least one user interface of a vehicle can comprise providing, by a system comprising a processor, user interface data of the at least one user interface, providing, by the system, user input data of an input of at least one user of the at least one user interface, providing, by the system, a user input model configured to analyze the user input data based on the user interface data and sensor data of the vehicle, processing, by the system and using the user input model, the user interface data and the user input data, and generating, by the system, user interface control data.

### CROSS-REFERENCE TO RELATED APPLICATIONS

This application claims the benefit of and priority to pending EP patent application serial number 22208361.0, filed Nov. 18, 2022, and entitled “METHOD FOR CONTROLLING AT LEAST ONE USER INTERFACE OF A VEHICLE,” the entirety of which is hereby incorporated by reference herein.

### TECHNICAL FIELD

The disclosed subject matter relates to vehicles and, more particularly, to controlling at least one user interface of a vehicle.

### BACKGROUND

Vehicles can comprise at least one user interface configured to display information of the vehicle and to acquire information of a user of the vehicle by means of a touch interaction between the user of the vehicle and the at least one user interface (e.g., a touchscreen). Thus, control elements in the interior of the vehicle are reduced and functions of the vehicle are controlled by means of touch interactions with the at least one user interface. Thereby, an operation of the touchscreen is simple and accurate when the vehicle is stationary, however, different lateral, vertical and/or longitudinal forces may occur during the movement of the vehicle, which lead to movements in the user's body and thus to incorrect entries on the touchscreen, such that required functions of the vehicle are not activated in time and accidents may occur.

The above-described background relating to vehicle user interfaces is merely intended to provide a contextual overview of some current issues and is not intended to be exhaustive. Other contextual information may become further apparent upon review of the following detailed description.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, devices, computer-implemented methods, apparatuses and/or computer program products that facilitate controlling a vehicle (e.g., with respect to a cyclist) are described.

As alluded to above, control of a user interface of a vehicle can be improved in various ways, and various embodiments are described herein to this end and/or other ends.

According to an embodiment, method for controlling at least one user interface of a vehicle can comprise providing, by a system comprising a processor, user interface data of the at least one user interface, providing, by the system, user input data of an input of at least one user of the at least one user interface, providing, by the system, a user input model configured to analyze the user input data based on the user interface data and sensor data of the vehicle, processing, by the system and using the user input model, the user interface data and the user input data, and generating, by the system, user interface control data.

According to another embodiment, a system for controlling at least one user interface of a vehicle can comprise a memory that stores computer executable components, and a processor that executes the computer executable components stored in the memory, wherein the computer executable components comprise a first providing component that provides user interface data of the at least one user interface, a second providing component that provides user input data of the at least one user interface, a third providing component that provides a user input model configured to analyze the user input data based on the user interface data and sensor data of the vehicle, and a processing component that processes the user interface data and the user input data using the user input model and generates user interface control data.

According to yet another embodiment, a non-transitory machine-readable medium, comprising executable instructions that, when executed by a processor, facilitate performance of operations, comprising providing user interface data of at least one user interface of a vehicle, providing user input data of an input of at least one user of the at least one user interface, providing a user input model configured to analyze the user input data based on the user interface data and sensor data of the vehicle, processing, using the user input model, the user interface data and the user input data, and generating user interface control data.

### BRIEF DESCRIPTION OF DRAWINGS

FIG. 1 illustrates a block diagram of an exemplary system in accordance with one or more embodiments described herein.

FIG. 2 illustrates a block diagram of example, non-limiting computer executable components in accordance with one or more embodiments described herein.

FIG. 3 illustrates an example, non-limiting user interface in a vehicle in accordance with one or more embodiments described herein.

FIG. 4 illustrates an example, non-limiting machine learning process in accordance with one or more embodiments described herein.

FIG. 5 illustrates a block flow diagram for a process associated with controlling a user interface of a vehicle in accordance with one or more embodiments described herein.

FIG. 6 is an example, non-limiting computing environment in which one or more embodiments described herein can be implemented.

FIG. 7 is an example, non-limiting networking environment in which one or more embodiments described herein can be implemented.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It will be understood that when an element is referred to as being “coupled” to another element, it can describe one or more different types of coupling including, but not limited to, chemical coupling, communicative coupling, capacitive coupling, electrical coupling, electromagnetic coupling, inductive coupling, operative coupling, conductive coupling, acoustic coupling, ultrasound coupling, optical coupling, physical coupling, thermal coupling, and/or another type of coupling. As referenced herein, an “entity” can comprise a human, a client, a user, a computing device, a software application, an agent, a machine learning model, an artificial intelligence, and/or another entity. It should be appreciated that such an entity can facilitate implementation of the subject disclosure in accordance with one or more embodiments the described herein.

The computer processing systems, computer-implemented methods, apparatus and/or computer program products described herein employ hardware and/or software to solve problems that are highly technical in nature (e.g., controlling a vehicle), that are not abstract and cannot be performed as a set of mental acts by a human.

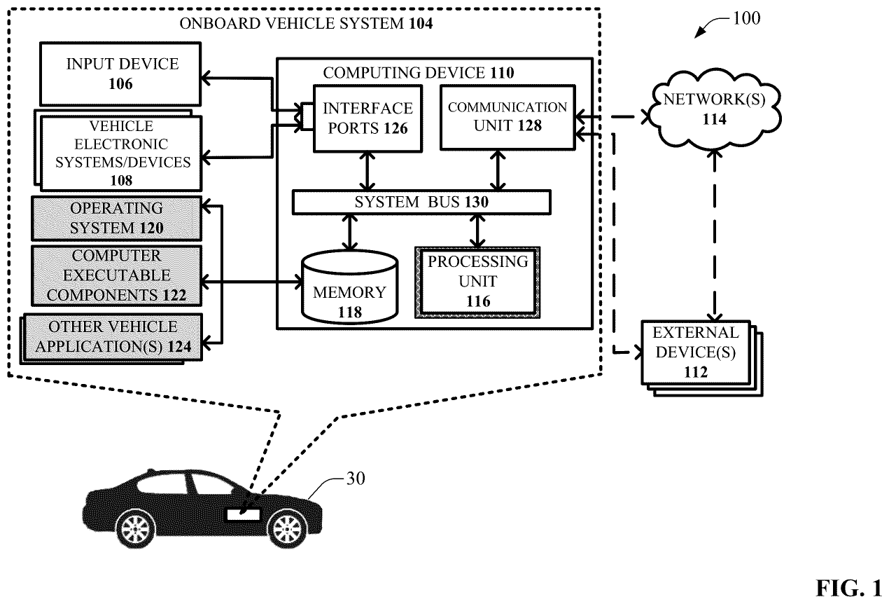

Turning now to FIG. 1, there is illustrated an example, non-limiting system 100 in accordance with one or more embodiments herein. System 100 can comprise a computerized tool, which can be configured to perform various operations relating to control of a user interface of a vehicle. In accordance with various exemplary embodiments, system 100 can be deployed on or within a vehicle 30, (e.g., an automobile, as shown in FIG. 1). Although FIG. 1 depicts the vehicle 30 as an automobile, the architecture of the system 100 is not so limited. For instance, the system 100 described herein can be implemented with a variety of types of vehicles 10. Example vehicles 10 that can incorporate the exemplary system 100 can include, but are not limited to: automobiles (e.g., autonomous vehicles or semi-autonomous vehicles), airplanes, trains, motorcycles, carts, trucks, semi-trucks, buses, boats, recreational vehicles, helicopters, jets, electric scooters, electric bicycles, a combination thereof, and/or the like. It is additionally noted that the system 100 can be implemented in a variety of types of automobiles, such as battery electric vehicles, hybrid vehicles, plug-in hybrid vehicles, internal combustion engine vehicles, or other suitable types of vehicles.

As shown in FIG. 1, the system 100 can comprise one or more onboard vehicle systems 104, which can comprise one or more input devices 106, one or more other vehicle electronic systems and/or devices 108, and/or one or more computing devices 110. Additionally, the system 100 can comprise one or more external devices 112 that can be communicatively and/or operatively coupled to the one or more computing devices 110 of the one or more onboard vehicle systems 104 either via one or more networks 114 and/or a direct electrical connection (e.g., as shown in FIG. 1). In various embodiments, one or more of the onboard vehicle system 104, input devices 106, vehicle electronic systems and/or devices 108, computing devices 110, external devices 112, and/or networks 114 can be communicatively or operably coupled (e.g., over a bus or wireless network) to one another to perform one or more functions of the system 100.

The one or more input devices 106 can display one or more interactive graphic entity interfaces (“GUIs”) that facilitate accessing and/or controlling various functions and/or application of the vehicle 30. The one or more input devices 106 can display one or more interactive GUIs that facilitate accessing and/or controlling various functions and/or applications. The one or more input devices 106 can comprise one or more computerized devices, which can include, but are not limited to: personal computers, desktop computers, laptop computers, cellular telephones (e.g., smartphones or mobile devices), computerized tablets (e.g., comprising a processor), smart watches, keyboards, touchscreens, mice, a combination thereof, and/or the like. An entity or user of the system 100 can utilize the one or more input devices 106 to input data into the system 100. Additionally, the one or more input devices 106 can comprise one or more displays that can present one or more outputs generated by the system 100 to an entity. For example, the one or more displays can include, but are not limited to: cathode tube display (“CRT”), light-emitting diode display (“LED”), electroluminescent display (“ELD”), plasma display panel (“PDP”), liquid crystal display (“LCD”), organic light-emitting diode display (“OLED”), a combination thereof, and/or the like.

For example, the one or more input devices 106 can comprise a touchscreen that can present one or more graphical touch controls that can respectively correspond to a control for a function of the vehicle 30, an application, a function of the application, interactive data, a hyperlink to data, and the like, wherein selection and/or interaction with the graphical touch control via touch activates the corresponding functionality. For instance, one or more GUIs displayed on the one or more input devices 106 can include selectable graphical elements, such as buttons or bars corresponding to a vehicle navigation application, a media application, a phone application, a back-up camera function, a car settings function, a parking assist function, and/or the like. In some implementations, selection of a button or bar corresponding to an application or function can result in the generation of a new window or GUI comprising additional selectable icons or widgets associated with the selected application. For example, selection of one or more selectable options herein can result in generation of a new GUI or window that includes additional buttons or widgets with one or more selectable options. The type and appearance of the controls can vary. For example, the graphical touch controls can include icons, symbols, widgets, windows, tabs, text, images, a combination thereof, and/or the like.

The one or more input devices 106 can comprise suitable hardware that registers input events in response to touch (e.g., by a finger, stylus, gloved hand, pen, etc.). In some implementations, the one or more input devices 106 can detect the position of an object (e.g., by a finger, stylus, gloved hand, pen, etc.) over the one or more input devices 106 within close proximity (e.g., a few centimeters) to touchscreen without the object touching the screen. As used herein, unless otherwise specified, reference to “on the touchscreen” refers to contact between an object (e.g., an entity's finger) and the one or more input devices 106 while reference to “over the touchscreen” refers to positioning of an object within close proximity to the touchscreen (e.g., a defined distance away from the touchscreen) yet not contacting the touchscreen.

The type of the input devices 106 can vary and can include, but is not limited to: a resistive touchscreen, a surface capacitive touchscreen, a projected capacitive touchscreen, a surface acoustic wave touchscreen, and an infrared touchscreen. In various embodiments, the one or more input devices 106 can be positioned on the dashboard of the vehicle 30, such as on or within the center stack or center console of the dashboard. However, the position of the one or more input devices 106 within the vehicle 30 can vary.

The one or more other vehicle electronic systems and/or devices 108 can include one or more additional devices and/or systems (e.g., in addition to the one or more input devices 106 and/or computing devices 110) of the vehicle 30 that can be controlled based at least in part on commands issued by the one or more computing devices 110 (e.g., via one or more processing units 116) and/or commands issued by the one or more external devices 112 communicatively coupled thereto. For example, the one or more other vehicle electronic systems and/or devices 108 can comprise: seat motors, seatbelt system(s), airbag system(s), display(s), infotainment system(s), speaker(s), a media system (e.g., audio and/or video), a back-up camera system, a heating, ventilation, and air conditioning (“HVAC”) system, a lighting system, a cruise control system, a power locking system, a navigation system, an autonomous driving system, a vehicle sensor system, telecommunications system, a combination thereof, and/or the like. Other example other vehicle electronic systems and/or devices 108 can comprise one or more sensors, which can comprise distance sensors, seats, seat position sensor(s), collision sensor(s), odometers, altimeters, speedometers, accelerometers, engine features and/or components, fuel meters, flow meters, cameras (e.g., digital cameras, heat cameras, infrared cameras, and/or the like), lasers, radar systems, lidar systems, microphones, vibration meters, moisture sensors, thermometers, seatbelt sensors, wheel speed sensors, a combination thereof, and/or the like. For instance, a speedometer of the vehicle 30 can detect the vehicle's traveling speed. Further, the one or more sensors can detect and/or measure one or more conditions outside the vehicle 30, such as: whether the vehicle 30 is traveling through a rainy environment, whether the vehicle 30 is traveling through winter conditions (e.g., snowy and/or icy conditions), whether the vehicle 30 is traveling through very hot conditions (e.g., desert conditions), and/or the like. Example navigational information can include, but is not limited to: the destination of the vehicle 30, the position of the vehicle 30, the type of vehicle 30, the speed of the vehicle 30, environmental conditions surrounding the vehicle 30, the planned route of the vehicle 30, traffic conditions expected to be encountered by the vehicle 30, operational status of the vehicle 30, a combination thereof, and/or the like.

The one or more computing devices 110 can facilitate executing and controlling one or more operations of the vehicle 30, including one or more operations of the one or more input devices 106, and the one or more other vehicle electronic systems/devices 108 using machine-executable instructions. In this regard, embodiments of system 100 and other systems described herein can include one or more machine-executable components embodied within one or more machines (e.g., embodied in one or more computer readable storage media associated with one or more machines, such as computing device 110). Such components, when executed by the one or more machines (e.g., processors, computers, virtual machines, etc.) can cause the one or more machines to perform the operations described.

For example, the one or more computing devices 110 can include or be operatively coupled to at least one memory 118 and/or at least one processing unit 116. The one or more processing units 116 can be any of various available processors. For example, dual microprocessors and other multiprocessor architectures also can be employed as the processing unit 116. In various embodiments, the at least one memory 118 can store software instructions embodied as functions and/or applications that when executed by the at least one processing unit 116, facilitate performance of operations defined by the software instruction. In the embodiment shown, these software instructions can include one or more operating system 120, one or more computer executable components 122, and/or one or more other vehicle applications 124. For example, the one or more operating systems 120 can act to control and/or allocate resources of the one or more computing devices 110. It is to be appreciated that the claimed subject matter can be implemented with various operating systems or combinations of operating systems.

The one or more computer executable components 122 and/or the one or more other vehicle applications 124 can take advantage of the management of resources by the one or more operating systems 120 through program modules and program data also stored in the one or more memories 118. The one or more computer executable components 122 can provide various features and/or functionalities that can facilitate prevention of pedestrian accidents herein. Example, other vehicle applications 124 can include, but are not limited to: a navigation application, a media player application, a phone application, a vehicle settings application, a parking assistance application, an emergency roadside assistance application, a combination thereof, and/or the like. The features and functionalities of the one or more computer executable components 122 are discussed in greater detail infra.

The one or more computing devices 110 can further include one or more interface ports 126, one or more communication units 128, and a system bus 130 that can communicatively couple the various features of the one or more computing devices 110 (e.g., the one or more interface ports 126, the one or more communication units 128, the one or more memories 118, and/or the one or more processing units 116). The one or more interface ports 126 can connect the one or more input devices 106 (and other potential devices) and the one or more other vehicle electronic systems/devices 108 to the one or more computing devices 110. For example, the one or more interface ports 126 can include, a serial port, a parallel port, a game port, a universal serial bus (“USB”) and the like.

The one or more communication units 128 can include suitable hardware and/or software that can facilitate connecting one or more external devices 112 to the one or more computing devices 110 (e.g., via a wireless connection and/or a wired connection). For example, the one or more communication units 128 can be operatively coupled to the one or more external devices 112 via one or more networks 114. The one or more networks 114 can include wired and/or wireless networks, including but not limited to, a personal area network (“PAN”), a local area network (“LAN”), a cellular network, a wide area network (“WAN”, e.g., the Internet), and the like. For example, the one or more external devices 112 can communicate with the one or more computing devices 110 (and vice versa) using virtually any desired wired or wireless technology, including but not limited to: wireless fidelity (“Wi-Fi”), global system for mobile communications (“GSM”), universal mobile telecommunications system (“UMTS”), worldwide interoperability for microwave access (“WiMAX”), enhanced general packet radio service (enhanced “GPRS”), fifth generation (“5G”) communication system, sixth generation (“6G”) communication system, third generation partnership project (“3GPP”) long term evolution (“LTE”), third generation partnership project 2 (“3GPP2”) ultra-mobile broadband (“UMB”), high speed packet access (“HSPA”), Zigbee and other 802.XX wireless technologies and/or legacy telecommunication technologies, near field communication (“NFC”)) technology, BLUETOOTH®, Session Initiation Protocol (“SIP”), ZIGBEE®, RF4CE protocol, WirelessHART protocol, 6LoWPAN (IPv6 over Low power Wireless Area Networks), Z-Wave, an ANT, an ultra-wideband (“UWB”) standard protocol, and/or other proprietary and non-proprietary communication protocols. In this regard, the one or more communication units 128 can include software, hardware, or a combination of software and hardware that is configured to facilitate wired and/or wireless communication between the one or more computing devices 110 and the one or more external devices 112. While the one or more communication units 128 are shown for illustrative clarity as a separate unit that is not stored within memory 118, it is to be appreciated that one or more (software) components of the communication unit can be stored in memory 118 and include computer executable components.

The one or more external devices 112 can include any suitable computing device comprising a display and input device (e.g., a touchscreen) that can communicate with the one or more computing devices 110 comprised within the onboard vehicle system 104 and interface with the one or more computer executable components 122 (e.g., using a suitable application program interface (“API”)). For example, the one or more external devices 112 can include, but are not limited to: a mobile phone, a smartphone, a tablet, a personal computer (“PC”), a digital assistant (“PDA”), a heads-up display (“HUD”), virtual reality (“VR”) headset, an augmented reality (“AR”) headset, or another type of wearable computing device, a desktop computer, a laptop computer, a computer tablet, a combination thereof, and the like.

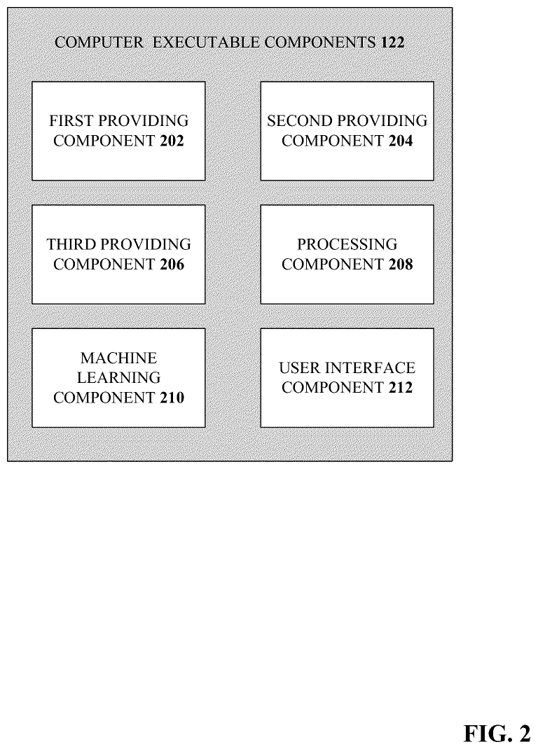

FIG. 2 illustrates a block diagram of example, non-limiting computer executable components 122 that can facilitate control of a user interface of a vehicle in accordance with one or more embodiments described herein. Repetitive description of like elements employed in other embodiments described herein is omitted for sake of brevity. As shown in FIG. 2, the one or more computer executable components 122 can comprise first providing component 202, second providing component 204, third providing component 206, processing component 208, machine learning component 210, and/or user interface component 212.

According to an embodiment, the first providing component 202 can provide user interface data of the at least one user interface 31. In various embodiments, the user interface data can comprise, for instance, information for displaying and/or configuring graphics and input area for the at least one user interface 31, in particular a GUI for the at least one user interface 31. For example, the user interface data can at least configure (e.g., via the user interface component 212) the GUI properties, structure, and/or function for the at least one user interface 31.

According to an embodiment, the second providing component 204 can provide user input data of an input of at least one user of the at least one user interface 31. In various embodiments, the user input data can comprise, for instance, information about an input of the at least one user to the at least one user interface 31, such as areas of the input and/or coordinates of the input. For example, the information can be xy-coordinates of the input on the at least one user interface 31, whereby the at least one user interface 31 can comprise xy-coordinates to determine the position of the input and associate the xy-coordinates with the input, such as the xy-coordinates are used on a touch screen. Further, the input can in particular be a touch of the at least one user on the at least one user interface 31 and the information may comprise an intensity of the touch.

According to an embodiment, the third providing component 206 can provide a user input model configured to analyze the user input data based on the user interface data and sensor data of the vehicle. In various embodiments, the user input model can comprise a machine learning process configured (e.g., via the machine learning component 210) to analyze the user input data based on the user interface data and the sensor data of the vehicle 30. In various embodiments, the machine learning process can be trained (e.g., via the machine learning component 210) by an initial personal calibration data, a generalizing augmented touch, an initial machine learning model data, and/or an augmentation over time data. In various embodiments, the machine learning process can be at least configured (e.g., via the machine learning component 210) to compensate a deviation of the user input data with respect to the user interface data. In further embodiments, the user input model can be configured (e.g., via the machine learning component 210) to further analyze the user input data based on a user profile. In various embodiments, the machine learning process herein can improve the interaction between the at least one user and the at least one user interface 31, whereby in particular the accuracy of touch inputs by the at least one user to the at least one user interface 31 can be improved by correcting unintended touch inputs.

In an implementation, the machine learning process herein can be trained (e.g., via the machine learning component 210) by an initial personal calibration data, a generalizing augmented touch data, an initial machine learning model data and/or an augmentation over time data. In various embodiments, the initial personal calibration data can be obtained (e.g., via the user interface component 212), for example, by a setup process in which the at least one user is prompted (e.g., via the user interface component 212) to press at specific locations of the at least one user interface 31. Stated otherwise, the initial personal calibration data can compensate for an individual offset of at least each user of the at least one user interface 31, whereby the touch inputs of at least each user from the at least one user interface 31 and user viewing angle of at least each user are taken into account (e.g., via the processing component 208 and/or machine learning component 210). Furthermore, the initial personal calibration can be set and/or adjusted in one or more settings of the vehicle 30. The generalized augmented touch data can be received (e.g., via the onboard vehicle system 104), for example, from a separate database that comprises generalized augmented touch data from different users. In various embodiments, the different generalized augmented touch data can, for example, comprise initial personal calibration data and/or collected data during real drive cycles while different users are interacting with the at least one user interface 31.

The initial machine learning model data can, for example, be received (e.g., via the onboard vehicle system 104) from a separate database containing data pre-trained by different users and/or test persons. In addition, the initial machine learning model data can be tested before it is provided by the separate database, whereby A/B testing can be used, for example. Further, various embodiments herein can have different machine learning model data available to the at least one user.

In various embodiments, the initial machine learning model data can comprise sensor data, touch input data, user angle of view, and/or data on GUI components used. Thereby, the initial machine learning model data can be collected (e.g., via the second providing component 204 or another suitable component), for example, while driving and while a test person is prompted (e.g., via the user interface component 212) to perform various tasks of using the GUI. It is noted that the initial machine learning model data can represent non-personalized model data that can be customized and/or enhanced by the at least one user during use and/or taking into account, for example, the viewpoint of the at least one user, whereby the customized and/or enhanced non-personalized model can be re-customized and/or enhanced for each user of the vehicle 30. In addition, the non-personalized model data can comprise data about a user's viewing angle and/or other sensor data specific to the user. Therefore, the non-personalized model data can become individual for each user during the usage time of the at least one user interface 31.

The augmentation over time data herein can be obtained, for instance, through an analysis (e.g., via the processing component 208 and/or machine learning component 210) of the user's continuous interaction with the at least one user interface 31. Thereby, training patterns can be characterized (e.g., via the processing component 208 and/or machine learning component 210) based on subsequent behavior of the at least one user and labelled based on the behavior, for example, if the at least one user presses outside next to an input component of the GUI and then presses on the respective input component and/or if the at least one user presses an input component of the GUI to start a function of the vehicle 30, subsequently stops the function, and subsequently presses another input component of the GUI adjacent to the input component.

In addition, data from at least one sensor (e.g., of the systems/devices 108) of the vehicle 30 and/or label data for each training pattern can also be associated (e.g., via the processing component 208 and/or machine learning component 210) with the augmentation data over time. For example, the label data can comprise whether the at least one user touched a correct or incorrect input component of the GUI. In this regard, touching the correct input component of the GUI can be detected (e.g., via the user interface component 212) based on the user's continued interaction with the GUI. Thereby, a touch of the incorrect input component of the GUI can be detected based on an abort of the function triggered thereby.

In various embodiments, the generalizing augmented touch data can be manually and/or automatically labeled (e.g., via the user interface component 212), whereby automated labeling can be inferred from a behavior of the at least one user, for example if the at least one user touched correctly or incorrectly.

In various embodiments, the machine learning process herein can be configured (e.g., via the machine learning component 210) to compensate a deviation of the user input data with respect to the user interface data. The deviation of the user input data can, for example, be considered a wrong input and/or unintended input of the at least one user. Likewise, this incorrect input and/or unintended input of the at least one user can unintentionally activate a function of the vehicle 30 which, in an unfavorable case, impedes the use of the vehicle 30 by a driver. The machine learning process herein can, for example, use (e.g., via the machine learning component 210) the initial personal calibration data, the generalizing augmented touch data, the initial machine learning model data, and/or the augmentation over time data to determine whether the input of the at least one user represent an intended input or an unintended input. Further, in the case of an unintended input, the machine learning process herein can correct (e.g., via the processing component 208 and/or the machine learning component 210) that unintended input to match to an intended input of the at least one user. For example, the machine learning process herein can compensate (e.g., via the processing component 208 and/or the machine learning component 210) for the user input data by determining whether the input of the at least one user is intended or unintended, wherein the compensating can be, for example, correcting the user input data to preferably to perform a desired function of the vehicle. Stated otherwise, the machine learning process can be configured (e.g., via the processing component 208 and/or the machine learning component 210) to compensate a faulty usage of an input component of the GUI of the at least one user, in particular in case different input component are provided by GUI, e.g., in case the different input components are arranged closely to each other.

In various embodiments, the sensor data herein can comprise movement, speed and/or acceleration values provided by a movement, speed and/or an accelerometer sensor (e.g., of the systems/devices 108) of the vehicle 30. In various implementations, the sensor data can comprise movement data of the movement of the vehicle 30, which can be used (e.g., via the processing component 208 and/or machine learning component 210) to compensate for hand movements of the at least one user due to the movement data while using the at least one user interface 31. In various embodiments, the sensor data can comprise view angle values which can be provided via an optical sensor (e.g., of the systems/devices 108) of the vehicle 30. In various embodiments, the sensor data can further comprise seating data of the seating of the at least one user, which can be used (e.g., via the processing component 208 and/or machine learning component 210) to compensate for an angle of view of the at least one user, whereby an offset angle can be calculated. In one or more embodiments, the optical sensor (e.g., of the systems/devices 108) can comprise a camera that is used in particular to determine the interior of the vehicle 30. In an implementation, the sensor data can comprise hand and/or arm movement values of the at least one user based on an optical sensor (e.g., of the systems/devices 108) of the vehicle 30. The optical sensor (e.g., of the systems/devices 108) can be further configured to detect small hand movements of the at least one user.

In an implementation, the user input model can be further configured (e.g., via the processing component 208 and/or the machine learning component 210) to analyze side offset values to compensate for an offset of a touch to an upper, lower, left and/or right side of a button of the at least one user of the at least one user interface 31.

The machine learning process can, for example, use (e.g., via the processing component 208 and/or the machine learning component 210) the initial personal calibration data, the generalizing augmented touch data, the initial machine learning model data, and/or the augmentation over time data to determine whether xy-coordinates of the input of the at least one user represent an intended input or an unintended input. Further, in the case of an unintended input, the machine learning process can (e.g., via the processing component 208 and/or the machine learning component 210) correct the xy-coordinates of the input in order to adjust respective values of the xy-coordinates of the input to match an intended input. In this respect, the deviation of the user input can, for example, be achieved by correcting the respective x and y values of the input. For example, the machine learning process can (e.g., via the processing component 208 and/or the machine learning component 210) compensate the xy-coordinates of the input of the at least one user by determining whether the input of the at least one user is intended or unintended, wherein the compensating can be, for example, correcting the xy-coordinates to preferably perform a desired function of the vehicle.

In various embodiments, the sensor data herein can comprise grip values with respect to grip intensities of the at least one user of the at least one user interface 31 onto the at least one user interface 31. In this regard, the sensor data can comprise the intensity of a touch of the at least one user on the at least one user interface 31, for example, the lightness or hardness of the touch of the at least one user. Further, the sensor data can comprise the extent of the pressure area due to the touch on the at least one user interface 31.

In various embodiments, the user input model herein can be configured to further analyze (e.g., via the processing component 208 and/or the machine learning component 210) the user input data based on a user profile. In this regard, the machine learning process can (e.g., via the processing component 208 and/or the machine learning component 210) use sensory data to improve the accuracy, whereby the machine learning process can compensate for a seated viewing angle of the at least one user by calculating an offset value for the at least one user interface 31, for a blocking view angle of the at least one user if the view of the at least one user of the at least one user interface 31 is blocked, for example, by the user's finger, and a touch input is given to a side of a button of the GUI by calculating an offset value for the at least one user interface 31 and/or any touch input given by the at least one user. Additionally, the machine learning process can (e.g., via the processing component 208 and/or the machine learning component 210) compensate for vibrations of the vehicle, hand movements of the at least one user in the air, and/or any small movements of the vehicle and/or the at least one user. In this regard, the GUI can further comprise input and/or output components, whereby these input and/or output components can be configured (e.g., via the user interface component 212) as graphical areas within the GUI, for example. Further, the input components can, for example, be configured (e.g., via the user interface component 212) to detect touch inputs of the at least one user in order to control a function of the vehicle. Moreover, the output components can, for example, be used to display functions of the vehicle. Moreover, the machine learning process can (e.g., via the machine learning component 212) compensate for incorrect touch inputs due to vibration, for example, of the vehicle if different input and/or output components of the GUI are too close to each other and/or incorrect touch inputs from smaller input components of the GUI. Furthermore, the machine learning process can (e.g., via the machine learning component 212) extend the touch range around an input component of the GUI, for example, if an input touch to a specific input component is expected and/or the at least one user approaches to a specific input component.

In various embodiments, the machine learning component 212 can adapt the machine learning process herein to better detect user intent in collected data samples of the initial personal calibration data, the generalizing augmented touch, the initial machine learning model data and/or the augmentation over time data, whereby the process can in particular be robust to noisy labels. Data samples can be collected (e.g., via the onboard vehicle system 104) for both training and testing purposes, for example, using the latter data samples as tests. Further, if a new version of the machine learning process performs better on the test cases, a new machine learning process can be used (e.g., via the machine learning component 212) instead of an old machine learning process.

In various embodiments, the sensor data can comprise movement, speed, and/or acceleration values determined via a movement, speed, and/or an accelerometer sensor (e.g., of the systems/devices 108) of the vehicle 30. In further embodiments, the sensor data can comprise view angle values generated via an optical sensor (e.g., of the systems/devices 108) of the vehicle 30. In further embodiments, the sensor data can comprise hand or arm movement values of the at least one user based on an optical sensor (e.g., of the systems/devices 108) of the vehicle 30. In further embodiments, the sensor data can comprise grip values with respect to grip intensities of the at least one user of the at least one user interface 31 onto the at least one user interface 31.

In various embodiments, the user input model can be further configured (e.g., via the machine learning component 210) to analyze side offset values to compensate for an offset of a touch to an upper, lower, left, and/or right side of a button of the at least one user of the at least one user interface 31.

According to an embodiment, the processing component 208 can process the user interface data and the user input data. In various embodiments, the processing component 208 can further generate user interface control data.

In various embodiments, the at least one user interface 31 can be configured (e.g., via the user interface component 212) as an output and/or input device for outputting information to the at least one user and/or for receiving information from the at least one user. Furthermore, the at least one user interface 31 can comprise a display and/or a sensor for outputting and/or receiving information, in particular, the at least one user interface 31 can comprise a touch screen.

By processing (e.g., via the processing component 208) the provided data and model, embodiments herein can be configured to interpret an input from the at least one user to determine whether the input from the at least one user was intended or unintended. If the input of the at least one user was unintended, the at least one user interface 31 can be controlled (e.g., via the user interface component 212) to correct the unintended input of the at least one user and replace the unintended input with an intended input of the at least one user interface 31. Stated otherwise, embodiments herein can be configured to interpret interaction of the at least one user with the help of data of sensors of the vehicle and the method to filter out unintended or wrong touches by accident. Therefore, the embodiments herein can use the GUI components of the at least one user interface 31 together with the data of the sensors in order to improve the interacting experience of the at least one user of the at least one user interface 31, in particular while the vehicle driving. In addition, embodiments herein can be used in various vehicles that have user interfaces and sensors, as there is no need for explicit control units. Therefore, embodiments herein can be configured to improve the touch accuracy of the at least one user, in particular while the vehicle is in motion and different lateral forces, vibrations, and wobble occur. In addition, embodiments herein can further assist the driver to focus on driving.

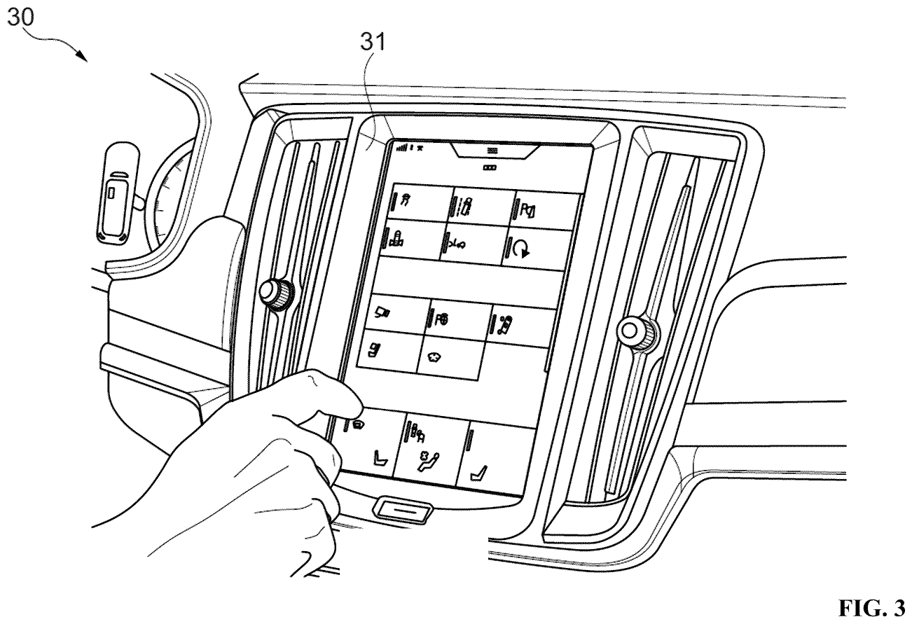

FIG. 3 shows a schematic diagram of an example of the disclosed system in a vehicle 30, whereby an interior of the vehicle 30 is shown in which at least one user interface 31 is arranged. Furthermore, at least one hand of at least one user is shown using the at least one user interface 31, whereby in the user interface a GUI is presented that comprises various input and/or output components.

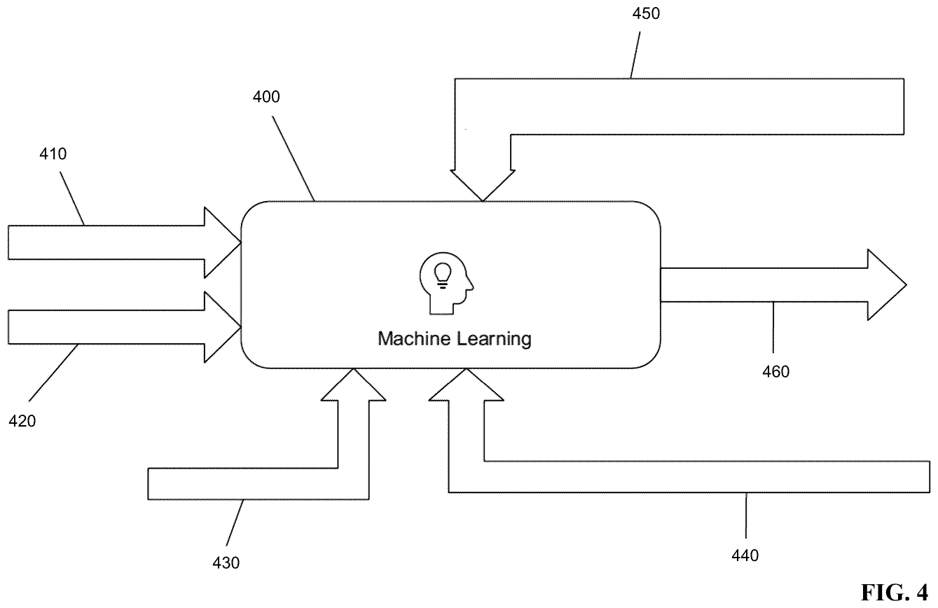

FIG. 4 shows a schematic illustration of an example of the used machine learning process 400, whereby the machine learning process 400 is provided with data input from the touch display 410 of the at least one user interface 31, input from sensors 420 of the vehicle 30, in particular the acceleration sensors, input from user profiles 430, input from calibrations 440, for example touch intensity and/or view angle calibration, and input from GUI 450 of the at least one user interface 31, for example how the GUI is structured and which functions it provides. The machine learning component 210 can, via the machine learning process 400, generate an output 460 representative of calculated control data. In this regard, the machine learning process 400 can (e.g., via the processing component 208 and/or machine learning component 210) analyze the provided input information/data to calculate control data for the at least one user interface 31 in order to be able to correct the detected touch inputs of the at least one user. In this regard, the calculated control data can be transmitted (e.g., via the processing component 208) to at least the at least one user interface 31.

Various embodiments herein can employ artificial-intelligence or machine learning systems and techniques to facilitate learning user behavior, context-based scenarios, preferences, etc. in order to facilitate taking automated action with high degrees of confidence. Utility-based analysis can be utilized to factor benefit of taking an action against cost of taking an incorrect action. Probabilistic or statistical-based analyses can be employed in connection with the foregoing and/or the following.

It is noted that systems and/or associated controllers, servers, or machine learning components herein can comprise artificial intelligence component(s) which can employ an artificial intelligence (A.I.) model and/or machine learning (M.L.) or an M.L. model that can learn to perform the above or below described functions (e.g., via training using historical training data and/or feedback data).

In some embodiments, machine learning component 210 can comprise an A.I. and/or M.L. model that can be trained (e.g., via supervised and/or unsupervised techniques) to perform the above or below-described functions using historical training data comprising various context conditions that correspond to various augmented network optimization operations. In this example, such an A.I. and/or M.L. model can further learn (e.g., via supervised and/or unsupervised techniques) to perform the above or below-described functions using training data comprising feedback data, where such feedback data can be collected and/or stored (e.g., in memory) by the machine learning component 210. In this example, such feedback data can comprise the various instructions described above/below that can be input, for instance, to a system herein, over time in response to observed/stored context-based information.

A.I./M.L. components herein can initiate an operation(s) associated with a based on a defined level of confidence determined using information (e.g., feedback data). For example, based on learning to perform such functions described above using feedback data, performance information, and/or past performance information herein, a machine learning component 210 herein can initiate an operation associated with determining various thresholds herein (e.g., a motion pattern thresholds, input pattern thresholds, similarity thresholds, authentication signal thresholds, audio frequency thresholds, or other suitable thresholds).

In an embodiment, the machine learning component 210 can perform a utility-based analysis that factors cost of initiating the above-described operations versus benefit. In this embodiment, the machine learning component 210 can use one or more additional context conditions to determine various thresholds herein.

To facilitate the above-described functions, a machine learning component 210 herein can perform classifications, correlations, inferences, and/or expressions associated with principles of artificial intelligence. For instance, the machine learning component 210 can employ an automatic classification system and/or an automatic classification. In one example, the machine learning component 210 can employ a probabilistic and/or statistical-based analysis (e.g., factoring into the analysis utilities and costs) to learn and/or generate inferences. The machine learning component 210 can employ any suitable machine-learning based techniques, statistical-based techniques and/or probabilistic-based techniques. For example, the machine learning component 210 can employ expert systems, fuzzy logic, support vector machines (SVMs), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or the like. In another example, the machine learning component 210 can perform a set of machine-learning computations. For instance, the machine learning component 210 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations.

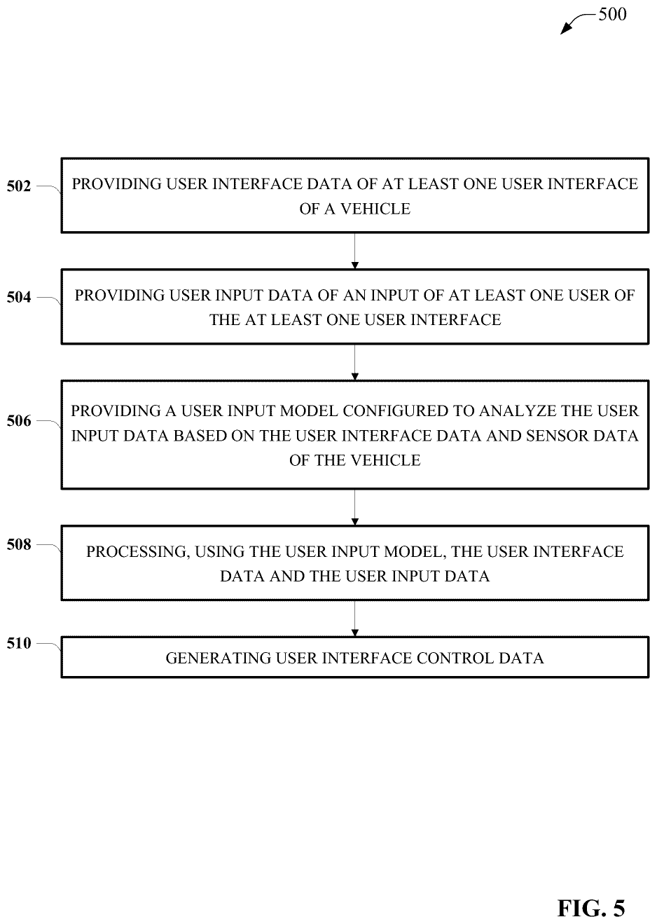

FIG. 5 illustrates a block flow diagram for a process 500 associated with control of a user interface of a vehicle in accordance with one or more embodiments described herein. At 502, the process 500 can comprise providing (e.g., via the first providing component 202) user interface data of at least one user interface 31 of a vehicle (e.g., vehicle 30). At 504, the process 500 can comprise providing (e.g., via the second providing component 204) user input data of an input of at least one user of the at least one user interface 31. At 506, the process 500 can comprise providing (e.g., via the third providing component 206) a user input model configured to analyze the user input data based on the user interface data and sensor data of the vehicle. At 508, the process 500 can comprise processing (e.g., via the processing component 208), using the user input model, the user interface data and the user input data. At 510, the process 500 can comprise generating (e.g., via the processing component 208) user interface control data.

Systems described herein can be coupled (e.g., communicatively, electrically, operatively, optically, inductively, acoustically, etc.) to one or more local or remote (e.g., external) systems, sources, and/or devices (e.g., electronic control systems (ECU), classical and/or quantum computing devices, communication devices, etc.). For example, system 100 (or other systems, controllers, processors, etc.) can be coupled (e.g., communicatively, electrically, operatively, optically, etc.) to one or more local or remote (e.g., external) systems, sources, and/or devices using a data cable (e.g., High-Definition Multimedia Interface (HDMI), recommended standard (RS), Ethernet cable, etc.) and/or one or more wired networks described below.

In some embodiments, systems herein can be coupled (e.g., communicatively, electrically, operatively, optically, inductively, acoustically, etc.) to one or more local or remote (e.g., external) systems, sources, and/or devices (e.g., electronic control units (ECU), classical and/or quantum computing devices, communication devices, etc.) via a network. In these embodiments, such a network can comprise one or more wired and/or wireless networks, including, but not limited to, a cellular network, a wide area network (WAN) (e.g., the Internet), and/or a local area network (LAN). For example, system 100 can communicate with one or more local or remote (e.g., external) systems, sources, and/or devices, for instance, computing devices using such a network, which can comprise virtually any desired wired or wireless technology, including but not limited to: powerline ethernet, VHF, UHF, AM, wireless fidelity (Wi-Fi), BLUETOOTH®, fiber optic communications, global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, Session Initiation Protocol (SIP), ZIGBEE®, RF4CE protocol, WirelessHART protocol, L-band voice or data information, 6LoWPAN (IPv6 over Low power Wireless Area Networks), Z-Wave, an ANT, an ultra-wideband (UWB) standard protocol, and/or other proprietary and non-proprietary communication protocols. In this example, system 100 can thus include hardware (e.g., a central processing unit (CPU), a transceiver, a decoder, an antenna (e.g., a ultra-wideband (UWB) antenna, a BLUETOOTH® low energy (BLE) antenna, etc.), quantum hardware, a quantum processor, etc.), software (e.g., a set of threads, a set of processes, software in execution, quantum pulse schedule, quantum circuit, quantum gates, etc.), or a combination of hardware and software that facilitates communicating information between a system herein and remote (e.g., external) systems, sources, and/or devices (e.g., computing and/or communication devices such as, for instance, a smart phone, a smart watch, wireless earbuds, etc.).

Systems herein can comprise one or more computer and/or machine readable, writable, and/or executable components and/or instructions that, when executed by processor (e.g., a processing unit 116 which can comprise a classical processor, a quantum processor, etc.), can facilitate performance of operations defined by such component(s) and/or instruction(s). Further, in numerous embodiments, any component associated with a system herein, as described herein with or without reference to the various figures of the subject disclosure, can comprise one or more computer and/or machine readable, writable, and/or executable components and/or instructions that, when executed by a processor, can facilitate performance of operations defined by such component(s) and/or instruction(s). Consequently, according to numerous embodiments, system herein and/or any components associated therewith as disclosed herein, can employ a processor (e.g., processing unit 116) to execute such computer and/or machine readable, writable, and/or executable component(s) and/or instruction(s) to facilitate performance of one or more operations described herein with reference to system herein and/or any such components associated therewith.

Systems herein can comprise any type of system, device, machine, apparatus, component, and/or instrument that comprises a processor and/or that can communicate with one or more local or remote electronic systems and/or one or more local or remote devices via a wired and/or wireless network. All such embodiments are envisioned. For example, a system (e.g., a system 100 or any other system or device described herein) can comprise a computing device, a general-purpose computer, field-programmable gate array, AI accelerator application-specific integrated circuit, a special-purpose computer, an onboard computing device, a communication device, an onboard communication device, a server device, a quantum computing device (e.g., a quantum computer), a tablet computing device, a handheld device, a server class computing machine and/or database, a laptop computer, a notebook computer, a desktop computer, wearable device, internet of things device, a cell phone, a smart phone, a consumer appliance and/or instrumentation, an industrial and/or commercial device, a digital assistant, a multimedia Internet enabled phone, a multimedia players, and/or another type of device.

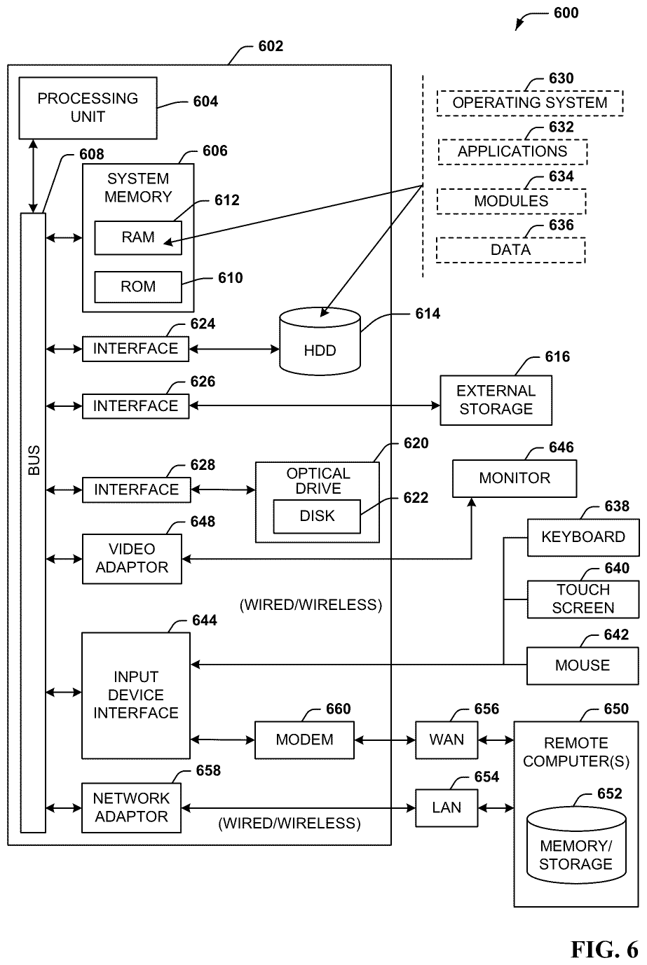

In order to provide additional context for various embodiments described herein, FIG. 6 and the following discussion are intended to provide a brief, general description of a suitable computing environment 600 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IOT) devices, distributed computing systems, as well as personal computers (e.g., ruggedized personal computers), field-programmable gate arrays, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, optic, infrared, and other wireless media.

With reference again to FIG. 6, the example environment 600 for implementing various embodiments of the aspects described herein includes a computer 602, the computer 602 including a processing unit 604, a system memory 606 and a system bus 608. The system bus 608 couples system components including, but not limited to, the system memory 606 to the processing unit 604. The processing unit 604 can be any of various commercially available processors, field-programmable gate array, AI accelerator application-specific integrated circuit, or other suitable processors. Dual microprocessors and other multi-processor architectures can also be employed as the processing unit 604.

The system bus 608 can be any of several types of bus structure that can further interconnect to a memory bus (with or without a memory controller), a peripheral bus, and a local bus using any of a variety of commercially available bus architectures. The system memory 606 includes ROM 610 and RAM 612. A basic input/output system (BIOS) can be stored in a non-volatile memory such as ROM, erasable programmable read only memory (EPROM), EEPROM, which BIOS contains the basic routines that help to transfer information between elements within the computer 602, such as during startup. The RAM 612 can also include a high-speed RAM such as static RAM for caching data. It is noted that unified Extensible Firmware Interface(s) can be utilized herein.

The computer 602 further includes an internal hard disk drive (HDD) 614 (e.g., EIDE, SATA), one or more external storage devices 616 (e.g., a magnetic floppy disk drive (FDD) 616, a memory stick or flash drive reader, a memory card reader, etc.) and an optical disk drive 620 (e.g., which can read or write from a disc 622 such as a CD-ROM disc, a DVD, a BD, etc.). While the internal HDD 614 is illustrated as located within the computer 602, the internal HDD 614 can also be configured for external use in a suitable chassis (not shown). Additionally, while not shown in environment 600, a solid-state drive (SSD) could be used in addition to, or in place of, an HDD 614. The HDD 614, external storage device(s) 616 and optical disk drive 620 can be connected to the system bus 608 by an HDD interface 624, an external storage interface 626 and an optical drive interface 628, respectively. The interface 624 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 612, including an operating system 630, one or more application programs 632, other program modules 634 and program data 636. All or portions of the operating system, applications, modules, and/or data can also be cached in the RAM 612. The systems and methods described herein can be implemented utilizing various commercially available operating systems or combinations of operating systems.

Computer 602 can optionally comprise emulation technologies. For example, a hypervisor (not shown) or other intermediary can emulate a hardware environment for operating system 630, and the emulated hardware can optionally be different from the hardware illustrated in FIG. 6. In such an embodiment, operating system 630 can comprise one virtual machine (VM) of multiple VMs hosted at computer 602. Furthermore, operating system 630 can provide runtime environments, such as the Java runtime environment or the .NET framework, for applications 632. Runtime environments are consistent execution environments that allow applications 632 to run on any operating system that includes the runtime environment. Similarly, operating system 630 can support containers, and applications 632 can be in the form of containers, which are lightweight, standalone, executable packages of software that include, e.g., code, runtime, system tools, system libraries and settings for an application.

Further, computer 602 can be enabled with a security module, such as a trusted processing module (TPM). For instance, with a TPM, boot components hash next in time boot components, and wait for a match of results to secured values, before loading a next boot component. This process can take place at any layer in the code execution stack of computer 602. e.g., applied at the application execution level or at the operating system (OS) kernel level, thereby enabling security at any level of code execution.

A user can enter commands and information into the computer 602 through one or more wired/wireless input devices, e.g., a keyboard 638, a touch screen 640, and a pointing device, such as a mouse 642. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 604 through an input device interface 644 that can be coupled to the system bus 608, but can be connected by other interfaces, such as a parallel port, an IEEE 1394 serial port, a game port, a USB port, an IR interface, a BLUETOOTH® interface, etc.

A monitor 646 or other type of display device can be also connected to the system bus 608 via an interface, such as a video adapter 648. In addition to the monitor 646, a computer typically includes other peripheral output devices (not shown), such as speakers, printers, etc.

The computer 602 can operate in a networked environment using logical connections via wired and/or wireless communications to one or more remote computers, such as a remote computer(s) 650. The remote computer(s) 650 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 652 is illustrated. The logical connections depicted include wired/wireless connectivity to a local area network (LAN) 654 and/or larger networks, e.g., a wide area network (WAN) 656. Such LAN and WAN networking environments are commonplace in offices and companies, and facilitate enterprise-wide computer networks, such as intranets, all of which can connect to a global communications network, e.g., the Internet.

When used in a LAN networking environment, the computer 602 can be connected to the local network 654 through a wired and/or wireless communication network interface or adapter 658. The adapter 658 can facilitate wired or wireless communication to the LAN 654, which can also include a wireless access point (AP) disposed thereon for communicating with the adapter 658 in a wireless mode.

When used in a WAN networking environment, the computer 602 can include a modem 660 or can be connected to a communications server on the WAN 656 via other means for establishing communications over the WAN 656, such as by way of the Internet. The modem 660, which can be internal or external and a wired or wireless device, can be connected to the system bus 608 via the input device interface 644. In a networked environment, program modules depicted relative to the computer 602 or portions thereof, can be stored in the remote memory/storage device 652. It will be appreciated that the network connections shown are example and other means of establishing a communications link between the computers can be used.

When used in either a LAN or WAN networking environment, the computer 602 can access cloud storage systems or other network-based storage systems in addition to, or in place of, external storage devices 616 as described above. Generally, a connection between the computer 602 and a cloud storage system can be established over a LAN 654 or WAN 656 e.g., by the adapter 658 or modem 660, respectively. Upon connecting the computer 602 to an associated cloud storage system, the external storage interface 626 can, with the aid of the adapter 658 and/or modem 660, manage storage provided by the cloud storage system as it would other types of external storage. For instance, the external storage interface 626 can be configured to provide access to cloud storage sources as if those sources were physically connected to the computer 602.

The computer 602 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

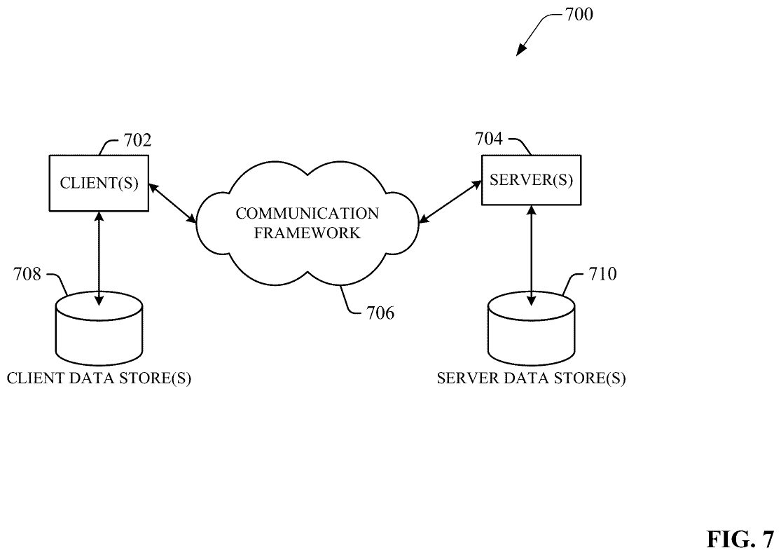

Referring now to FIG. 7, there is illustrated a schematic block diagram of a computing environment 700 in accordance with this specification. The system 700 includes one or more client(s) 702, (e.g., computers, smart phones, tablets, cameras, PDA's). The client(s) 702 can be hardware and/or software (e.g., threads, processes, computing devices). The client(s) 702 can house cookie(s) and/or associated contextual information by employing the specification, for example.

The system 700 also includes one or more server(s) 704. The server(s) 704 can also be hardware or hardware in combination with software (e.g., threads, processes, computing devices). The servers 704 can house threads to perform transformations of media items by employing aspects of this disclosure, for example. One possible communication between a client 702 and a server 704 can be in the form of a data packet adapted to be transmitted between two or more computer processes wherein data packets may include coded analyzed headspaces and/or input. The data packet can include a cookie and/or associated contextual information, for example. The system 700 includes a communication framework 706 (e.g., a global communication network such as the Internet) that can be employed to facilitate communications between the client(s) 702 and the server(s) 704.

Communications can be facilitated via a wired (including optical fiber) and/or wireless technology. The client(s) 702 are operatively connected to one or more client data store(s) 708 that can be employed to store information local to the client(s) 702 (e.g., cookie(s) and/or associated contextual information). Similarly, the server(s) 704 are operatively connected to one or more server data store(s) 710 that can be employed to store information local to the servers 704. Further, the client(s) 702 can be operatively connected to one or more server data store(s) 710.

In one exemplary implementation, a client 702 can transfer an encoded file, (e.g., encoded media item), to server 704. Server 704 can store the file, decode the file, or transmit the file to another client 702. It is noted that a client 702 can also transfer uncompressed file to a server 704 and server 704 can compress the file and/or transform the file in accordance with this disclosure. Likewise, server 704 can encode information and transmit the information via communication framework 706 to one or more clients 702.

The illustrated aspects of the disclosure can also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature can be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Further aspects of the invention are provided by the subject matter of the following clauses:
1. A method for controlling at least one user interface of a vehicle, comprising:
providing, by a system comprising a processor, user interface data of the at least one user interface;
providing, by the system, user input data of an input of at least one user of the at least one user interface;
providing, by the system, a user input model configured to analyze the user input data based on the user interface data and sensor data of the vehicle;
processing, by the system and using the user input model, the user interface data and the user input data; and
generating, by the system, user interface control data.
2. The method of any preceding clause, wherein the user input model comprises a machine learning process configured to analyze the user input data based on the user interface data and the sensor data of the vehicle.
3. The method of any preceding clause, wherein the machine learning process is trained by an initial personal calibration data, a generalizing augmented touch, an initial machine learning model data, or an augmentation over time data.
4. The method of any preceding clause, wherein the machine learning process is at least configured to compensate a deviation of the user input data with respect to the user interface data.
5. The method of any preceding clause, wherein the sensor data comprises movement, speed, or acceleration values determined via a movement, speed, or an accelerometer sensor of the vehicle.
6. The method of any preceding clause, wherein the sensor data comprises view angle values generated via an optical sensor of the vehicle.
7. The method of any preceding clause, wherein the sensor data comprises hand or arm movement values of the at least one user based on an optical sensor of the vehicle.
8. The method of any preceding clause, wherein the user input model is further configured to analyze side offset values to compensate for an offset of a touch to an upper, lower, left, or right side of a button of the at least one user of the at least one user interface.
9. The method of any preceding clause, wherein the sensor data comprises grip values with respect to grip intensities of the at least one user of the at least one user interface onto the at least one user interface.
10. The method of any preceding clause, wherein the user input model is configured to further analyze the user input data based on a user profile.
11. The method of clause 1 above with any set of combinations of the methods 2-10 above.
12. A system for controlling at least one user interface of a vehicle, comprising:
a memory that stores computer executable components; and
a processor that executes the computer executable components stored in the memory, wherein the computer executable components comprise:
a first providing component that provides user interface data of the at least one user interface;
a second providing component that provides user input data of the at least one user interface;
a third providing component that provides a user input model configured to analyze the user input data based on the user interface data and sensor data of the vehicle; and
a processing component that processes the user interface data and the user input data using the user input model and generates user interface control data.
13. The system of any preceding clause, wherein the computer executable components further comprise:
a machine learning component that analyzes the user input data based on the user interface data and the sensor data of the vehicle.
14. The system of any preceding clause, wherein the computer executable components further comprise:
a user interface component that controls a user interface of the vehicle.
15. The system of any preceding clause, wherein the user input model comprises a machine learning process configured to analyze the user input data based on the user interface data and the sensor data of the vehicle.
16. The system of any preceding clause, wherein the machine learning process is trained by an initial personal calibration data, a generalizing augmented touch, an initial machine learning model data, or an augmentation over time data.
17. The system of any preceding clause, wherein the machine learning process is at least configured to compensate a deviation of the user input data with respect to the user interface data.
18. The system of any preceding clause, wherein the sensor data comprises movement, speed, or acceleration values determined via a movement, speed, or an accelerometer sensor of the vehicle.
19. The system of any preceding clause, wherein the sensor data comprises view angle values generated via an optical sensor of the vehicle.
20. The system of clause 12 above with any set of combinations of the systems 13-19 above.
21. A non-transitory machine-readable medium, comprising executable instructions that, when executed by a processor, facilitate performance of operations, comprising:
providing user interface data of at least one user interface of a vehicle;
providing user input data of an input of at least one user of the at least one user interface;
providing a user input model configured to analyze the user input data based on the user interface data and sensor data of the vehicle;
processing, using the user input model, the user interface data and the user input data; and
generating user interface control data.
22 The non-transitory machine-readable medium of any preceding clause, wherein the user input model comprises a machine learning process configured to analyze the user input data based on the user interface data and the sensor data of the vehicle.

What is claimed is:

1. A method for controlling at least one user interface of a vehicle, comprising:
providing, by a system comprising a processor, user interface data of the at least one user interface;
providing, by the system, user input data of an input of at least one user of the at least one user interface;
providing, by the system, a user input model configured to analyze the user input data based on the user interface data and sensor data of the vehicle;
processing, by the system and using the user input model, the user interface data and the user input data; and
generating, by the system, user interface control data.

2. The method of claim 1, wherein the user input model comprises a machine learning process configured to analyze the user input data based on the user interface data and the sensor data of the vehicle.

3. The method of claim 2, wherein the machine learning process is trained by an initial personal calibration data, a generalizing augmented touch, an initial machine learning model data, or an augmentation over time data.

4. The method of claim 2, wherein the machine learning process is at least configured to compensate a deviation of the user input data with respect to the user interface data.

5. The method of claim 1, wherein the sensor data comprises movement, speed, or acceleration values determined via a movement, speed, or an accelerometer sensor of the vehicle.

6. The method of claim 1, wherein the sensor data comprises view angle values generated via an optical sensor of the vehicle.

7. The method of claim 1, wherein the sensor data comprises hand or arm movement values of the at least one user based on an optical sensor of the vehicle.

8. The method of claim 1, wherein the user input model is further configured to analyze side offset values to compensate for an offset of a touch to an upper, lower, left, or right side of a button of the at least one user of the at least one user interface.

9. The method of claim 1, wherein the sensor data comprises grip values with respect to grip intensities of the at least one user of the at least one user interface onto the at least one user interface.

10. The method of claim 1, wherein the user input model is configured to further analyze the user input data based on a user profile.

11. A system for controlling at least one user interface of a vehicle, comprising:
a memory that stores computer executable components; and
a processor that executes the computer executable components stored in the memory, wherein the computer executable components comprise:
a first providing component that provides user interface data of the at least one user interface;
a second providing component that provides user input data of the at least one user interface;
a third providing component that provides a user input model configured to analyze the user input data based on the user interface data and sensor data of the vehicle; and
a processing component that processes the user interface data and the user input data using the user input model and generates user interface control data.

12. The system of claim 11, wherein the computer executable components further comprise:
a machine learning component that analyzes the user input data based on the user interface data and the sensor data of the vehicle.

13. The system of claim 11, wherein the computer executable components further comprise:
a user interface component that controls a user interface of the vehicle.

14. The system of claim 11, wherein the user input model comprises a machine learning process configured to analyze the user input data based on the user interface data and the sensor data of the vehicle.

15. The system of claim 14, wherein the machine learning process is trained by an initial personal calibration data, a generalizing augmented touch, an initial machine learning model data, or an augmentation over time data.

16. The system of claim 14, wherein the machine learning process is at least configured to compensate a deviation of the user input data with respect to the user interface data.

17. The system of claim 11, wherein the sensor data comprises movement, speed, or acceleration values determined via a movement, speed, or an accelerometer sensor of the vehicle.

18. The system of claim 11, wherein the sensor data comprises view angle values generated via an optical sensor of the vehicle.

19. A non-transitory machine-readable medium, comprising executable instructions that, when executed by a processor, facilitate performance of operations, comprising:
providing user interface data of at least one user interface of a vehicle;
providing user input data of an input of at least one user of the at least one user interface;
providing a user input model configured to analyze the user input data based on the user interface data and sensor data of the vehicle;
processing, using the user input model, the user interface data and the user input data; and
generating user interface control data.

20. The non-transitory machine-readable medium of claim 19, wherein the user input model comprises a machine learning process configured to analyze the user input data based on the user interface data and the sensor data of the vehicle.
